(19) United States
(12) Patent Application Publication
(10) Pub. No.: US 2026/0242002 A1
(43) Pub. Date: Aug. 20, 2026

(54) MOLDED VEHICLE FRAME COMPONENT

(71) Applicant: TOYOTA JIDOSHA KABUSHIKI KAISHA, Toyota-shi (JP)

(72) Inventor: Hiromu KOTAKI, Seto-shi (JP)

(73) Assignee: TOYOTA JIDOSHA KABUSHIKI KAISHA, Toyota-shi (JP)

(21) Appl. No.: 19/373,475

(22) Filed: Oct. 29, 2025

(30) Foreign Application Priority Data
Feb. 19, 2025 (JP) 2025-025444

(51) Int. Cl. B62D 25/08; B22D 31/00

(52) U.S. Cl. CPC B62D 25/08; B22D 31/00

(57) ABSTRACT

A rib connecting an upper wall portion and a lower wall portion is provided at a substantially central portion of the overflow portion in a vehicle front-rear direction in a portion where the overflow portion is provided. As a result, compared to when the rib is not provided, the rigidity of the upper member is improved, the rib functions as a reinforcing structure, and can resist a bending moment, so that it is possible to suppress cracking of the molded vehicle frame component that occurs when the overflow portion is cut off.

### CROSS-REFERENCE TO RELATED APPLICATION

This application claims priority to Japanese Patent Application No. 2025-025444 filed on February 19, 2025. The disclosure of the above-identified application, including the specification, drawings, and claims, is incorporated by reference herein in its entirety.

### BACKGROUND

### 1. Technical Field

The present disclosure relates to a molded vehicle frame component.

### 2. Description of Related Art

Japanese Unexamined Patent Application Publication No. 2005-111488 (JP 2005-111488 A) discloses a technique concerning a trimming device that uses a trimming die to cut off an overflow portion of a casting. The related art is a trimming method of cutting off and removing the overflow portion of the casting using upper and lower trimming dies. In the trimming method, an end portion of a workpiece receiving surface of the lower die is brought into linear contact with a workpiece, and shearing is carried out from an upper surface of the workpiece with a cutting edge of the upper die. Thereafter, fracture is induced in the workpiece by using a linear contact portion between the lower die and the workpiece as a fulcrum, and a fracture surface is guided toward the linear contact portion.

### SUMMARY

Incidentally, when a vehicle frame is integrally molded by die casting, an overflow portion is provided at a portion on an outer side in a vehicle width direction, such as a front upper member, to suppress flash. In this case, the overflow portion is fractured (cut off) by a trimming die (trimming press) after the vehicle frame is molded.

Considering the above facts, an object of the present disclosure is to obtain a molded vehicle frame component capable of suppressing cracking of a main body of the molded vehicle frame component that occurs when an overflow portion is cut off.

A molded vehicle frame component according to a first aspect is a molded vehicle frame component integrally molded by casting. The molded vehicle frame component includes:

an upper member that is provided on an upper side of the molded vehicle frame component in a vehicle up-down direction, is open on an outer side in a vehicle width direction, and has a cross-section that is substantially U-shaped when cut along the vehicle width direction and the vehicle up-down direction;

an overflow-portion trace that is provided on an upper wall portion constituting an upper end portion of the upper member in the vehicle up-down direction, the overflow-portion trace being a trace left after an overflow portion extending outward from a tip end of the upper wall portion in the vehicle width direction is cut off; and

a rib that is provided on a lower side of the upper wall portion in the vehicle up-down direction in a portion where the overflow-portion trace is provided, the rib connecting a lower wall portion constituting a lower end portion of the upper member in the vehicle up-down direction to the upper wall portion.

In the molded vehicle frame component according to the first aspect, the molded vehicle frame component is integrally molded by casting, and includes the upper member, the overflow-portion trace, and the rib. The upper member is provided on the upper side of the molded vehicle frame component in the vehicle up-down direction, is open on the outer side in the vehicle width direction, and has the cross-section that is substantially U-shaped when cut along the vehicle width direction and the vehicle up-down direction.

The overflow-portion trace is provided on the upper wall portion constituting the upper end portion of the upper member in the vehicle up-down direction, and the overflow-portion trace is defined as a trace left after the overflow portion extending outward from the tip end of the upper wall portion in the vehicle width direction is cut off. In the present aspect, by providing the overflow-portion trace in the upper wall portion of the upper member, it is possible to suppress flash during casting.

Meanwhile, the rib is provided on a lower side of the upper wall portion of the upper member in the vehicle up-down direction in the portion where the overflow-portion trace is provided, and the rib is configured to connect the lower wall portion constituting the lower end portion of the upper member in the vehicle up-down direction to the upper wall portion.

The upper member is open on the outer side in the vehicle width direction, has the cross-section that is substantially U-shaped when cut along the vehicle width direction and the vehicle up-down direction, and includes the upper wall portion and the lower wall portion. Therefore, in the present aspect, by providing the rib connecting the upper wall portion and the lower wall portion of the upper member, the rigidity of the upper member is improved compared to when the rib is not provided.

The overflow portion is cut off after the molded vehicle frame component is molded, for example, by a trimming press through the overflow-portion trace. When the overflow portion is cut off, a bending moment acts along the vehicle up-down direction, originating at a root portion of the upper wall portion, on an upper wall portion side of the upper member where the overflow portion is provided.

In the present aspect, since the rib connecting the upper wall portion and the lower wall portion is provided in the upper member, the rib functions as a reinforcing structure and can resist the bending moment. As a result, in the present aspect, it is possible to suppress cracking of the molded vehicle frame component that occurs when the overflow portion is cut off.

According to a second aspect of the molded vehicle frame component, in the molded vehicle frame component according to the first aspect, the tip end of the upper wall portion is connected to the overflow portion through a notch portion that is thinner than other portions of the upper wall portion.

In the molded vehicle frame component according to the second aspect, the tip end of the upper wall portion is connected to the overflow portion through the notch portion. Since the notch portion is thinner than other portions of the upper wall portion of the upper member, when the overflow portion is cut off by the trimming press, the notch portion serves as a fracture-initiation point, causing the overflow portion to be cut off (removed).

As described above, in the present aspect, by providing the fracture-initiation point of the upper wall portion of the upper member, the overflow portion can be effectively cut off. As a result, it is possible to reduce the deformation load acting on the upper wall portion of the upper member and to suppress cracking of the molded vehicle frame component.

As described above, the molded vehicle frame component according to the present disclosure can suppress cracking of the main body of the molded vehicle frame component that occurs when the overflow portion is cut off.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a molded vehicle frame component according to the present embodiment, as viewed from a right oblique front and an upper side of the molded vehicle frame component in a state of being removed from a mold;

FIG. 2 is a perspective view showing a main part of the molded vehicle frame component according to the present embodiment, as viewed from an oblique front and a lower side;

FIG. 3 is a perspective view showing a main part of the molded vehicle frame component according to the present embodiment, as viewed from an oblique front and an upper side;

FIG. 4 is a cross-sectional view showing a main part of the molded vehicle frame component according to the present embodiment;

FIG. 5 is a cross-sectional view showing a trimming press used for the molded vehicle frame component according to the present embodiment;

FIG. 6A is a plan view schematically showing a main part of the molded vehicle frame component according to the present embodiment, and showing a case where one rib is provided in the molded vehicle frame component; and

FIG. 6B is a plan view schematically showing a main part of the molded vehicle frame component according to the present embodiment, and showing a case where two ribs are provided in the molded vehicle frame component.

### DETAILED DESCRIPTION OF EMBODIMENTS

Hereinafter, a molded vehicle frame component according to an embodiment of the present disclosure will be described with reference to the drawings. In each of the drawings, an arrow FR shown as appropriate indicates a front side in a vehicle front-rear direction, and an arrow UP indicates an upper side in a vehicle up-down direction. An arrow RH indicates a right side in a vehicle width direction, and indicates an outer side in the vehicle width direction in the present embodiment. Hereinafter, unless otherwise specified, the front-rear, up-down, and right-left directions used in the following description respectively refer to the front and rear in the vehicle front-rear direction, the up and down direction in the vehicle up-down direction, and the right and left in the vehicle left-right direction (vehicle width direction).

### Configuration of Molded Vehicle Frame Component

First, the configuration of a molded vehicle frame component according to the present embodiment will be described.

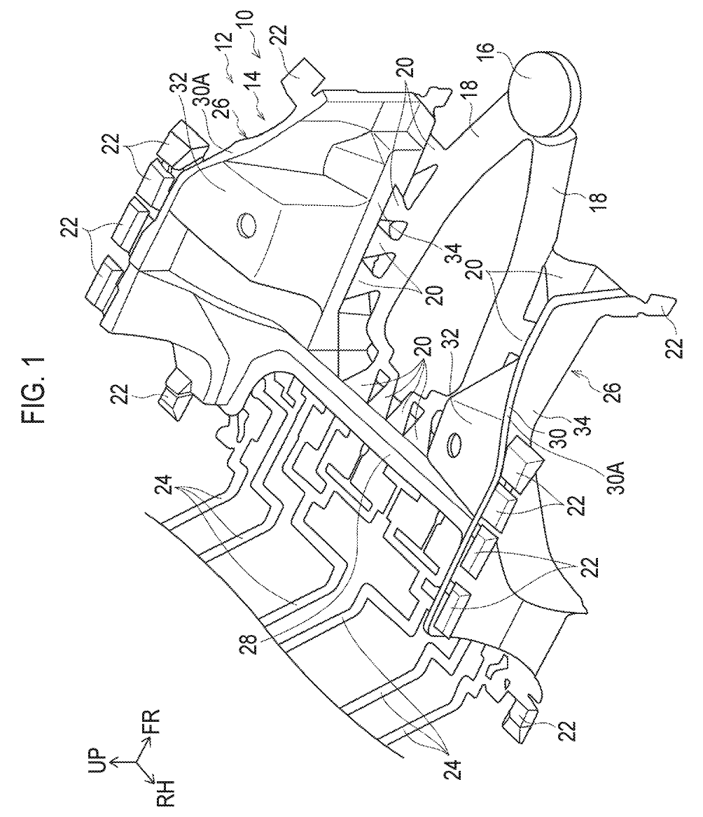

FIG. 1 shows a molded vehicle frame component 14 according to the present embodiment. The molded vehicle frame component 14 is integrally molded by casting using an aluminum alloy or the like as a material. In FIG. 1, the molded vehicle frame component 14 is in a state of being released (removed) from a mold (not shown). In FIG. 1, the molded vehicle frame component 14 is shown in a state where the sprue 16, the runner 18, the gate 20, the overflow portion 22, the vent runner 24, and the like remain attached.

The molded vehicle frame component 14 is a vehicle frame member provided in, for example, a front portion (hereinafter, referred to as a "vehicle front portion") 12 of the vehicle 10. Although not shown, the vehicle 10 is, for example, a battery electric vehicle, a fuel cell electric vehicle, or the like that travels using power generated by a power unit.

Here, the molded vehicle frame component 14 is provided with wheel houses 26, in which front wheels (not shown) are disposed on the right and left sides of the vehicle front portion 12, and the right wheel house 26 is connected to the left wheel house 26 by a cross member 28. Upper members 30 extend along the vehicle front-rear direction at upper end portions of the respective wheel houses 26, and suspension towers (hereinafter referred to as "suspension towers") 32 are provided on inner sides of the upper members 30 in the vehicle width direction. A front side member 34 extends in the vehicle front-rear direction on a lower side of the suspension tower 32.

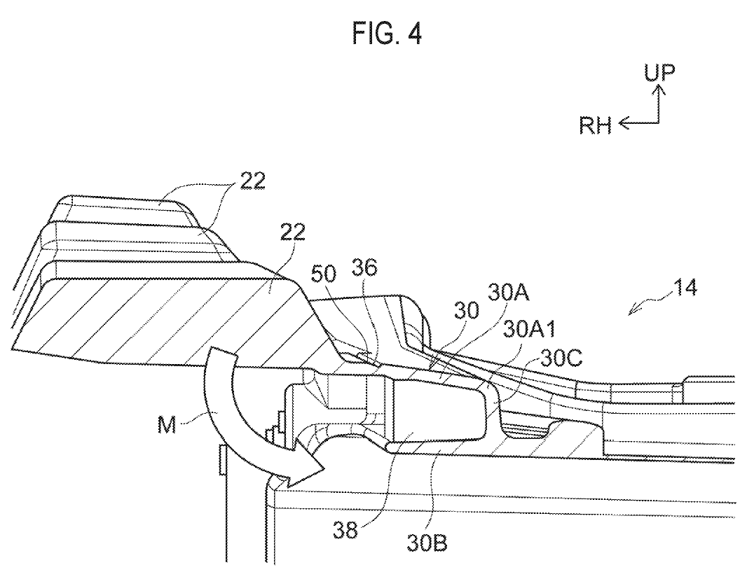

Here, as shown in FIG. 4, the upper member 30 is configured to include an upper wall portion 30A, a lower wall portion 30B, and an inner wall portion 30C. The upper wall portion 30A constitutes an upper end portion in the vehicle up-down direction. The lower wall portion 30B constitutes a lower end portion in the vehicle up-down direction. The inner wall portion 30C connects the inner end of the upper wall portion 30A in the vehicle width direction and the inner end of the lower wall portion 30B in the vehicle width direction. That is, the upper member 30 is open on the outer side in the vehicle width direction, and has a cross-section that is substantially U-shaped when cut along the vehicle width direction and the vehicle up-down direction.

As shown in FIG. 1, the gate 20 of the molded vehicle frame component 14 is provided on the lower end portion side of the molded vehicle frame component 14, here, the front side member 34 side. During molding of the molded vehicle frame component 14, the molten metal flowing in from the gate 20 is filled into the mold that molds the molded vehicle frame component 14.

The upper member 30 is disposed at a position away from the gate 20. That is, the upper member 30 is provided on a downstream side in a flow direction of the molten metal. Therefore, a plurality of overflow portions 22 is provided on the outer side of the upper member 30 in the vehicle width direction. As described above, by providing the overflow portion 22, it is possible to suppress the occurrence of a short shot, a sink, and the like of the upper member 30, to easily release the pressure in the mold, and to prevent flash during molding.

In the present embodiment, the overflow portion 22 has, for example, a substantially rectangular parallelepiped shape with the vehicle front-rear direction as a longitudinal direction, and extends from the tip end of the upper wall portion 30A of the upper member 30 toward the outer side in the vehicle width direction. The shape of the overflow portion 22 is not particularly limited.

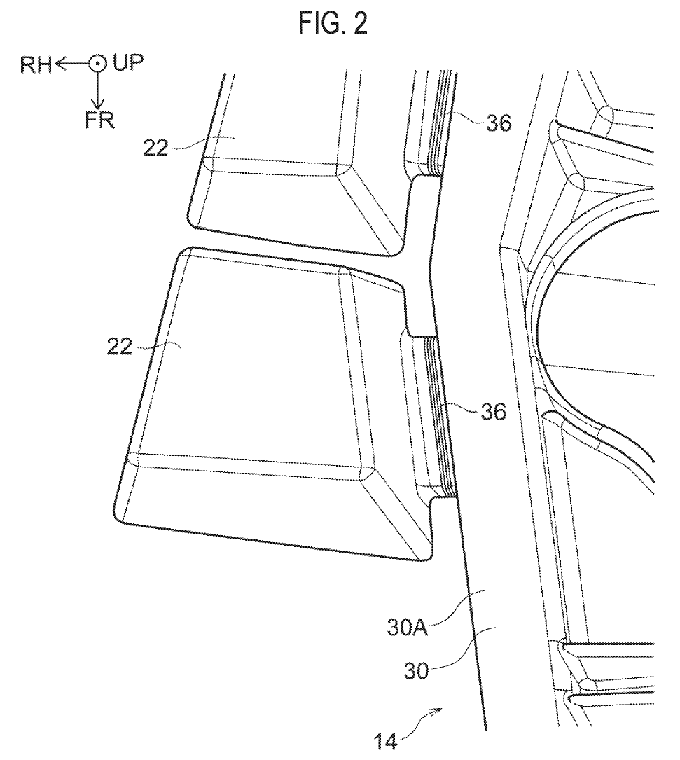

In the present embodiment, as shown in FIGS. 2 and 4, the overflow portion 22 is connected to the tip end of the upper wall portion 30A of the upper member 30 through the notch portion 36. The notch portion 36 is provided by being cut into a substantially trapezoidal shape in which the width is narrowed toward the lower side of the vehicle, and is thinner than other portions of the upper wall portion 30A.

The notch portion 36 only needs to be thinner than other portions of the upper wall portion 30A, and thus the shape thereof is not particularly limited. For example, the notch portion 36 may be provided by being cut into a V-shape or an arc shape.

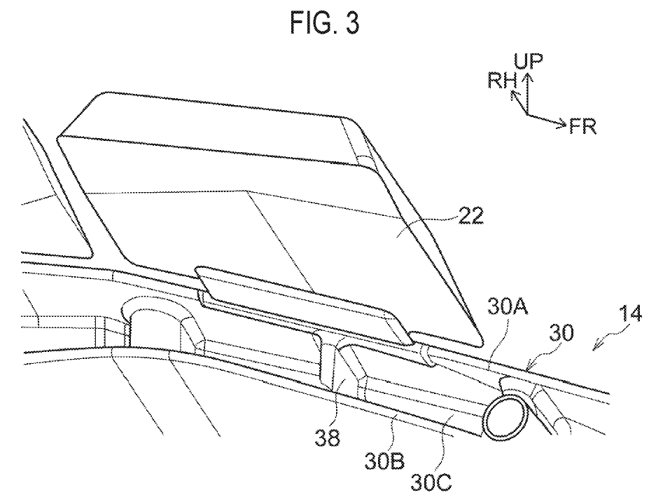

In addition, in the upper member 30, as shown in FIGS. 3 and 4, the rib 38 connecting the upper wall portion 30A and the lower wall portion 30B is provided at a substantially central portion of the overflow portion 22 in the vehicle front-rear direction in a portion where the overflow portion 22 is provided. The tip end of the rib 38 is slightly shorter than the tip ends of the upper wall portion 30A and the lower wall portion 30B, and is provided not to protrude from the tip ends of the upper wall portion 30A and the lower wall portion 30B.

### Operation and Effect of Molded Vehicle Frame Component

Next, the operation and effect of the molded vehicle frame component according to the present embodiment will be described.

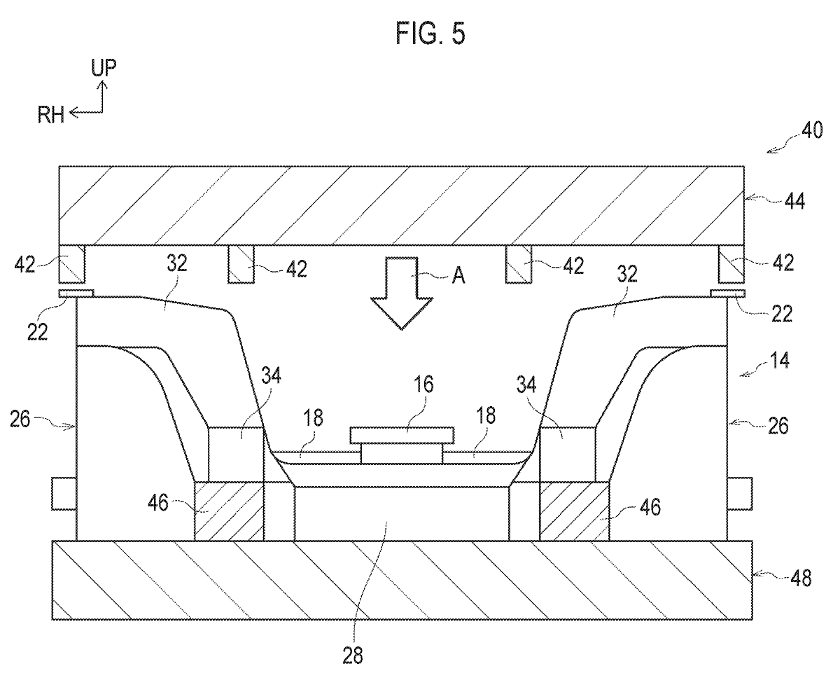

As shown in FIG. 1, in a state of being removed from the mold, the sprue 16, the runner 18, the gate 20, the overflow portion 22, the vent runner 24, and the like are integrally provided in the molded vehicle frame component 14 (remain attached). Therefore, after the molded vehicle frame component 14 is removed from the mold, the sprue 16, the runner 18, the gate 20, the overflow portion 22, and the vent runner 24 are all cut off by the trimming press 40 shown in FIG. 5 and are removed from the molded vehicle frame component 14. The sprue 16, the runner 18, the gate 20, the overflow portion 22, the vent runner 24, and the like to be removed may be collectively referred to as a removal portion.

The trimming press 40 is configured to include an upper die 44 provided with an upper blade 42 and a lower die 48 provided with a lower blade 46, and the molded vehicle frame component 14 is supported by the lower die 48. Then, the upper die 44 moves to a lower side (arrow A direction) with respect to the lower die 48, and the upper blade 42 comes into contact with the removal portion, such as the overflow portion 22, so that the removal portion is cut off.

Here, in the present embodiment, as shown in FIG. 4, the upper member 30 is open on the outer side in the vehicle width direction, and has a cross-section that is substantially U-shaped when cut along the vehicle width direction and the vehicle up-down direction. Therefore, the upper member 30 cannot be supported by the lower blade 46.

In this case, when the upper blade 42 (see FIG. 5) comes into contact with the overflow portion 22, a bending moment M acts along the vehicle up-down direction, originating at the root portion 30A1 of the upper wall portion 30A, on the upper wall portion 30A side of the upper member 30. That is, a deformation load is applied to the upper member 30 side, and deformation or cracking may occur in the molded vehicle frame component 14.

Therefore, in the present embodiment, the rib 38 connecting the upper wall portion 30A and the lower wall portion 30B is provided at a substantially central portion of the overflow portion 22 in the vehicle front-rear direction in a portion where the overflow portion 22 is provided. As a result, in the present embodiment, compared to when the rib 38 is not provided, the rigidity of the upper member 30 is improved, and the rib 38 functions as a reinforcing structure and can resist the bending moment M.

As a result, in the present embodiment, it is possible to suppress cracking of the molded vehicle frame component 14 that occurs when the overflow portion 22 is cut off.

In addition, in the present embodiment, the tip end of the upper wall portion 30A of the upper member 30 is connected to the overflow portion 22 through the notch portion 36. Accordingly, when the overflow portion 22 is cut off by the trimming press 40, the notch portion 36 serves as a fracture-initiation point, causing the overflow portion 22 to be cut off.

As described above, in the present embodiment, by providing the fracture-initiation point of the upper wall portion 30A of the upper member 30, the overflow portion 22 can be effectively cut off. As a result, in the present embodiment, it is possible to reduce the deformation load acting on the upper wall portion 30A of the upper member 30 and to suppress cracking of the molded vehicle frame component.

The overflow portion 22 is cut off and removed by the trimming press 40 shown in FIG. 5 after the molded vehicle frame component 14 is removed from the mold. That is, the overflow portion 22 is separated from the molded vehicle frame component 14. Therefore, a part of the notch portion 36 shown in FIGS. 2 and 4 remains on the molded vehicle frame component 14 as an overflow-portion trace 50.

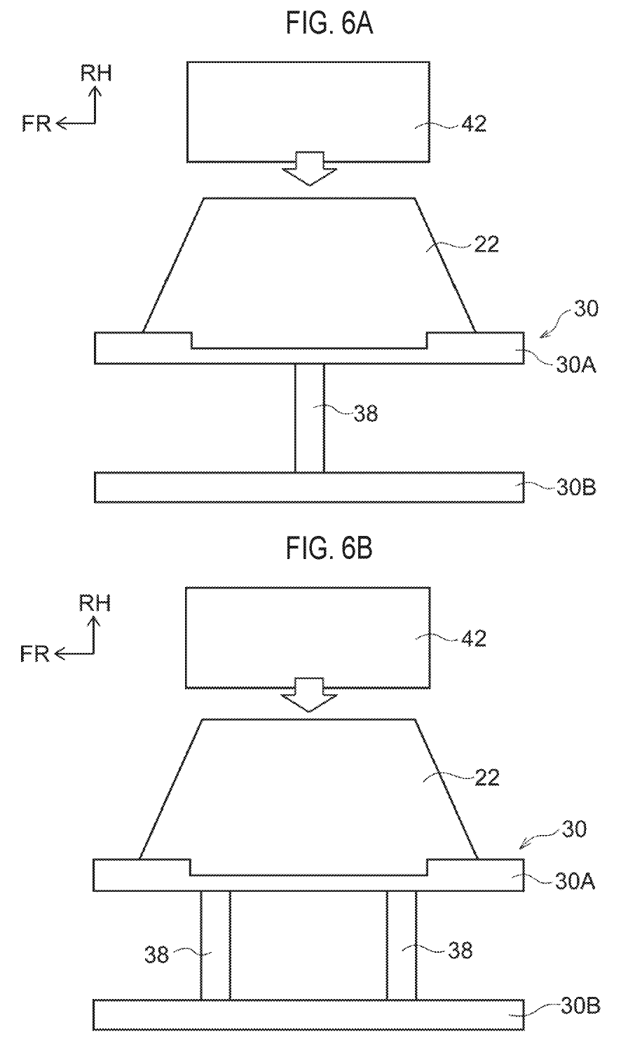

In addition, in the present embodiment, as shown in FIG. 6A, the rib 38 is provided at a substantially central portion of the overflow portion 22 in the vehicle front-rear direction in a portion where the overflow portion 22 is provided in the upper member 30. However, the disposition of the rib 38 is not limited thereto.

For example, as shown in FIG. 6B, the rib 38 may be provided at each of both end portions of the overflow portion 22 in the vehicle front-rear direction. That is, a plurality of the ribs 38 may be provided in the portion where the overflow portion 22 is provided in the upper member 30. As a result, the rigidity of the upper member 30 is further improved. In addition, the stress (deformation load) generated when cutting off the overflow portion 22 from the upper wall portion 30A of the upper member 30 can be dispersed. As a result, it is possible to further suppress cracking of the molded vehicle frame component 14.

Further, in the embodiment described above, the molded vehicle frame component 14 provided in the vehicle front portion has been described as the molded vehicle frame component integrally molded by casting, but the present embodiment may be applied to a vehicle frame member provided in a vehicle rear portion.

Although an embodiment of the present disclosure has been described above, the present disclosure is not limited to such an embodiment. The present disclosure may be used by appropriately combining the embodiment and various modifications. The present disclosure may be implemented in various aspects without departing from the gist of the present disclosure.

What is claimed is:

1. A molded vehicle frame component integrally molded by casting, the molded vehicle frame component comprising:
an upper member that is provided on an upper side of the molded vehicle frame component in a vehicle up-down direction, is open on an outer side in a vehicle width direction, and has a cross-section that is substantially U-shaped when cut along the vehicle width direction and the vehicle up-down direction;
an overflow-portion trace that is provided on an upper wall portion constituting an upper end portion of the upper member in the vehicle up-down direction, the overflow-portion trace being a trace left after an overflow portion extending outward from a tip end of the upper wall portion in the vehicle width direction is cut off; and
a rib that is provided on a lower side of the upper wall portion in the vehicle up-down direction in a portion where the overflow-portion trace is provided, the rib connecting a lower wall portion constituting a lower end portion of the upper member in the vehicle up-down direction to the upper wall portion.

2. The molded vehicle frame component according to claim 1, wherein the tip end of the upper wall portion is connected to the overflow portion through a notch portion that is thinner than other portions of the upper wall portion.
